(19) United States
(12) Patent Application Publication
(10) Pub. No.: US 2014/0245533 A1
(43) Pub. Date: Sep. 4, 2014

(54) EXPANDABLE SINK CADDY

(71) Applicant: ROBINSON HOME PRODUCTS INC., WILLIAMSVILLE, NY (US)

(72) Inventors: Stuart Harvey Lee, Forest Hills, NY (US); Jenna Marie Edgemon, Brooklyn, NY (US)

(73) Assignee: ROBINSON HOME PRODUCTS INC., WILLIAMSVILLE, NY (US)

(21) Appl. No.: 14/188,450

(22) Filed: Feb. 24, 2014

Related U.S. Application Data
(60) Provisional application No. 61/771,746, filed on Mar. 1, 2013.

(51) Int. Cl. A47J 47/20

(52) U.S. Cl. CPC A47J 47/20
USPC 4/630

(57) ABSTRACT

An expandable sink caddy having a front plate, a substantially rigid back plate, a flexible section extending between at least a portion of the sides, tops and bottoms of the front and back plates and one or more vertical attachment members for attaching the sink caddy to a vertical surface in a sink. The flexible section includes two or more living hinges to adapt the caddy from a closed configuration, where the front plate and back plate are maintained in relatively close relation, to an open configuration, where the front plate and back plate are maintained in a relatively spaced apart relation. Apertures are included in a lower portion of the sink caddy to drain liquid that may be directed into the sink caddy.

### FIELD OF THE INVENTION

The present invention relates to a container or storage device, for holding and storing implements and items commonly used in connection with a kitchen or bathroom sink.

### BACKGROUND OF THE INVENTION

Containers or storage devices for holding and storing sink-related implements and items are sometimes referred to as a sink caddy. Sink caddies are useful for holding a variety of items such as hand soap, dish soap, sponges, cleaning brushes, lotion, hand sanitizer, dish gloves, toothbrushes, toothpaste tubes, hairbrushes, shampoos and similar items. Sink caddies of the prior art have fixed dimensions and as a result are often bulkier and take up more space than the requirements of the user. In addition, sink caddies are frequently placed on the inner-wall of a sink and thus have a tendency to get in the way of the user when the sink is in use, especially when the contents have been removed for use in the sink.

U.S. Pat. No. 8,296,876 and U.S. Patent Application Publication No. 2010/0176017 both describe a sink organizer having a vertically expanding cup at the bottom of the organizer permitting the user to place longer items into the organizer. In addition, U.S. Design Pat. Nos. D642,841; D453,651; D512,255; D637,850 and D636,201 all depict variations of sink caddies or similar storage devices which employ suction cups for mounting the device to a wall or sink. However, the sink caddies of the prior art do not disclose a sink caddy which can be expanded or contracted based on the size of the items placed in the sink caddy.

Accordingly, a need exists for a sink caddy that can be expanded and contracted based on the size of the items placed in the sink caddy in order to maximize space efficiency. In addition, a need exists for a sink caddy that can be contracted when the items it holds are in use thus maximizing the effective useful area of the sink.

### SUMMARY OF THE INVENTION

The present invention is directed generally to an expandable sink caddy comprising a front plate and a substantially rigid back plate wherein the front plate and back plate are joined by a flexible accordion section and one or more attachment members for attaching the sink caddy to a vertical surface. The front plate, back plate and accordion section are joined about the sides and bottom so as to define a partially enclosed volume adapted to receive one or more items.

The accordion section comprises two or more living hinges that allow the sink caddy to be collapsed and expanded to permit the user to determine an optimal size for the sink caddy, depending on whether or not items are being stored in the sink caddy and/or the size of the items being stored. The accordion section thereby allows the sink caddy to be maximally contracted, closed or collapsed so as to take up minimal space when the items stored in the sink caddy are in use or when the sink caddy is empty or placed in storage.

In the preferred embodiment of the present invention, the attachment members are formed on the back plate of the sink caddy so as to attach to a vertical surface such as the inner wall of a sink. The most preferred attachment members are one or more suction cups, however, other suitable attachment members, as are known to those skilled in the art, may be used. Optionally, one or more hangers can be incorporated with the sink caddy, the hanger being formed as an inverted “L” member with the shorter side of the inverted “L” intended to fit over the edge of a sink to prevent the sink caddy from slipping down the side of the sink.

In a further preferred embodiment of the present invention, the sink caddy comprises one or more bores, including holes, apertures or other openings, to allow water or other liquids to drain from the partially enclosed volume of the sink caddy. It is preferred that the one or more bores be placed on the lower portion of the accordion section of the sink caddy to facilitate drainage.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a front, top perspective view of a preferred embodiment of the expandable sink caddy of the present invention.

FIG. 2 is a back perspective view of a preferred embodiment of the expandable sink caddy of the present invention.

FIG. 3 is a front, bottom perspective view of a preferred embodiment of the expandable sink caddy of the present invention.

FIG. 4 is a top view of a preferred embodiment of the expandable sink caddy of the present invention.

FIG. 5 is side view of a preferred embodiment of the expandable sink caddy of the present invention.

FIG. 6 is a side view of an alternative embodiment of the expandable sink caddy of the present invention.

### DETAILED DESCRIPTION OF THE PREFERRED EMBODIMENT

The following description of the preferred embodiment is presented to describe the present invention without limiting the scope of the appended claims in any manner whatsoever.

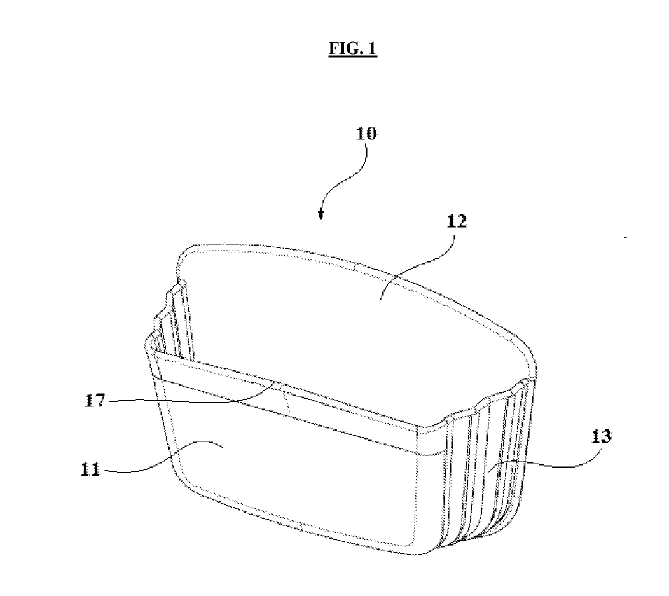

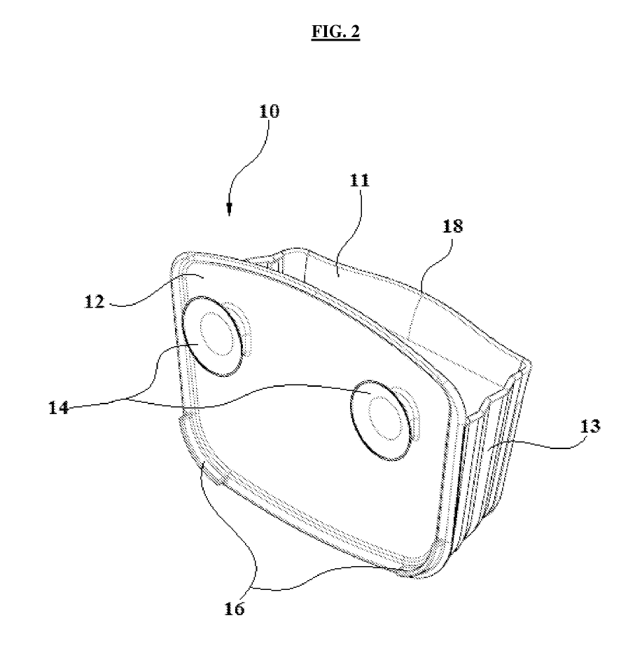

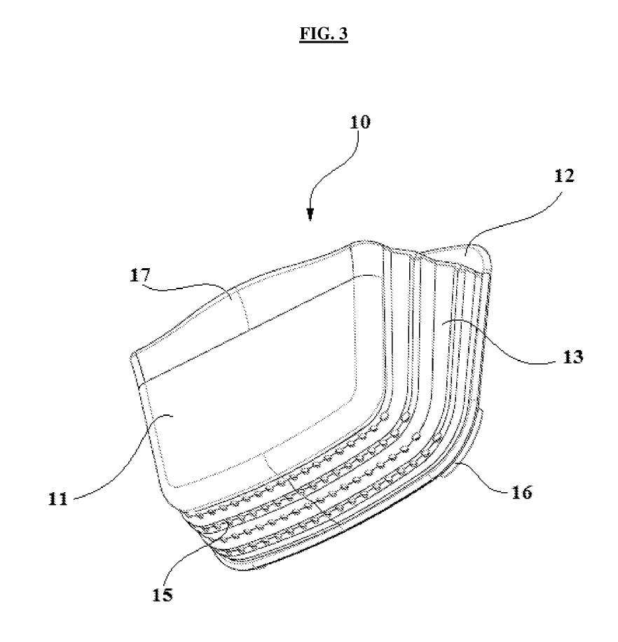

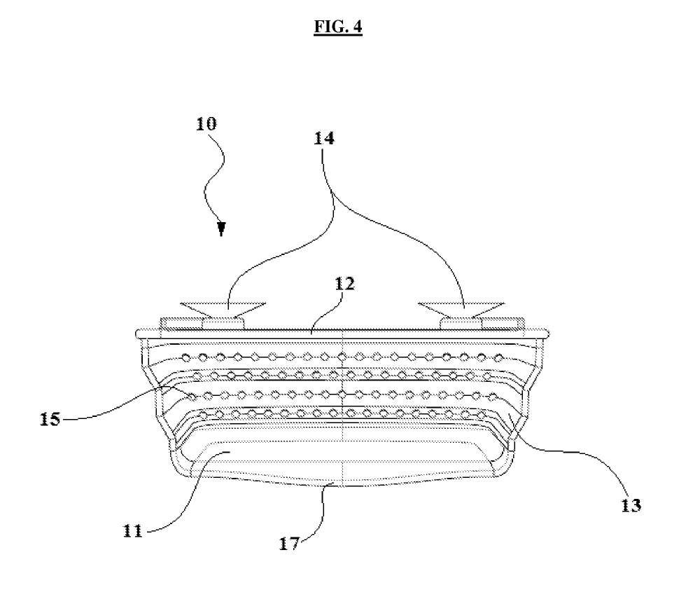

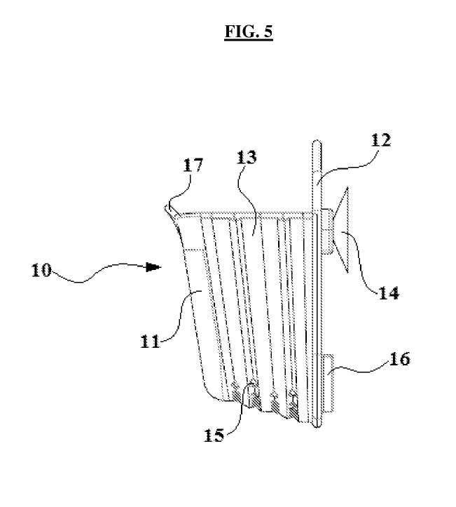

In a preferred embodiment, shown in accompanying FIGS. 1-5, the sink caddy 10 is formed of a front plate 11 and a substantially rigid back plate 12, wherein the front plate 11 and back plate 12 are joined by a flexible accordion section 13 having 2 or more living hinges. One or more attachment members 14 are preferably mounted on the back plate 12 for attaching the sink caddy 10 to the vertical wall of a sink.

In the preferred embodiment of the present invention, the front plate 11 is formed to be substantially rigid to aid in expanding and contracting the sink caddy 10. However, a flexible front plate 11 may be used if desired. Moreover, it is generally preferred, but not necessary, that the back plate 12 may be of a greater width and greater height than the front plate 11.

The front plate 11 and back plate 12 each have an outer surface and an inner surface. The front plate 11 and back plate 12 are joined about their sides and bottom by an accordion section 13 to define a partially enclosed volume between the inner surfaces of the front plate 11 and back plate 12, which is adapted to receive one or more items. Accordingly, the sink caddy 10 of the present invention should be sized so that the partially enclosed volume is large enough to wholly or partially contain one or more of a bar of soap, a hand soap pump bottle, dish soap, a sponge, a cleaning brush, dish gloves, a toothbrush, a toothpaste tube, a hairbrush, a shampoo bottle or the like.

The front plate 11 and back plate 12 are affixed to the accordion section 13 by any suitable means known in the art, including, but not limited to, molding or adhering the front plate 11 and back plate 12 to the accordion section 13. Alternatively, the front plate 11 and back plate 12 may comprise tabs which are received by corresponding slots in the accordion section 13 or vice versa. Of course, when the front plate 11 is not formed of a substantially rigid material, it may be formed of the flexible material of the accordion section 13. In this embodiment, the front plate 11 and accordion section 13 may be unitarily formed.

The accordion section 13, and optionally the front plate 11, may be formed of any suitable flexible material, and is preferably formed of an elastomeric thermoplastic material. The front plate 11 and back plate 12, are preferably, however, formed of any suitable substantially rigid material such as glass, stainless steel, aluminum or plastic. A preferred material for the front plate 11 and back plate 12 is an acrylonitrile butadiene styrene (ABS) plastic.

The preferred embodiment of the present invention illustrated shows the sink caddy 10 comprising one or more bores 15. The one or more bores 15 allow water or other liquids to drain from the partially enclosed volume of the sink caddy 10. It is preferred that the one or more bores 15 be placed in the accordion section 13. However, it is also contemplated that the one or more bores 15 could additionally, or alternatively, be placed in the front plate 11 or back plate 12. In a most preferred embodiment of the present invention, the one or more bores 15 are placed only in the lower third of the sink caddy 10.

In the preferred embodiment of the present invention shown, the outer surface of the back plate 12 comprises one or more attachment members 14 for attaching the sink caddy 10 to a vertical surface. The attachment members 14 can be any suitable structure, including suction cups, adhesive tape, adhesive, magnets, hook and loop fasteners, hooks, clips, snaps, clamps, nails, screws or combinations thereof. In a preferred embodiment of the present invention, the attachment members 14 comprise one or more suction cups, and preferably two suction cups.

To obtain maximum adhesion, the two suction cups forming the attachment members 14 of the preferred embodiment shown should be placed horizontally in line to one another on the upper half of the back plate 12 and spaced at least about one inch apart, with placement further apart being more preferred.

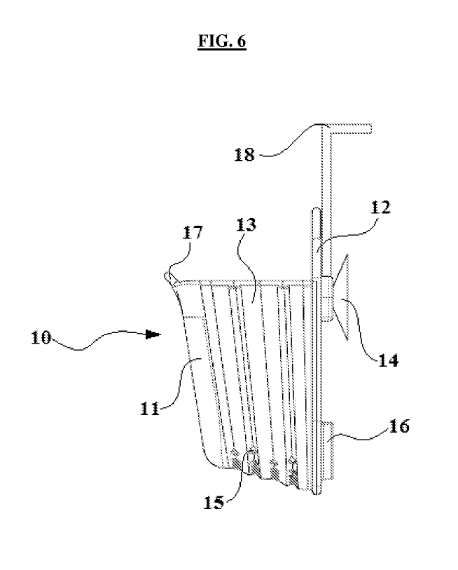

As shown in FIG. 6, one or more hangers 18 can optionally be incorporated with the sink caddy 10. The hanger 18 is preferably formed as an inverted “L” member with one side of the inverted “L” intended to fit over the edge of a sink as a stop, to prevent the sink caddy 10 from slipping down the side of the sink. Moreover, the hanger 18 is preferably adjustable on the sink caddy 10 for user determination of the sink caddy on the sink wall, and/or removable if the user does not wish to use the hanger 18.

In one embodiment of the present invention, the upper portion of the front plate 11 may further comprise an outwardly and/or upwardly extending tab 17. The tab 17 provides an area for the user to grasp when expanding and contracting the sink caddy 10. The tab 17 also provides an amount of additional space between the front plate 11 and back plate 12 allowing the sink caddy 10 to accommodate larger or oddly-shaped items.

In a further embodiment of the present invention, the outer surface of the back plate 12 may comprise one or more bumpers 16, preferably extending outwardly a distance which is just less than the depth of the attachment members 14 on the back plate 12. The bumpers 16 on the back plate 12 permit the sink caddy 10 to sit more vertically level when attached to the vertical side wall of a sink.

Variations, modifications and alterations to the above detailed description will be apparent to those skilled in the art. All such variations, modifications and/or alternatives are intended to fall within the scope of the present invention, limited only by the claims. All cited patents and publications are hereby incorporated by reference.

We claim:

1. An expandable sink caddy comprising a front plate, a substantially rigid back plate, a flexible section extending between at least a portion of the sides, tops and bottoms of the front and back plates, and one or more vertical attachment members for attaching the sink caddy to a vertical surface, the flexible section comprising two or more living hinges to adapt the caddy from a closed configuration, where the front plate and back plate are maintained in relatively close relation, to an open configuration, where the front plate and back plate are maintained in a relatively spaced apart relation.

2. The expandable sink caddy of claim 1 wherein the one or more vertical attachment members are taken from the group consisting of suction cups, adhesive tape, adhesive, magnets, hook and loop fasteners, hooks, clips, snaps, clamps, nails, screws and combinations thereof.

3. The expandable sink caddy of claim 2 wherein the one or more vertical attachment members comprise one or more suction cups on the back plate.

4. The expandable sink caddy of claim 3 comprising two suction cups disposed horizontally on a rearward facing surface of the back plate.

5. The expandable sink caddy of claim 4 wherein the two suction cups are on a top half of the back plate.

6. The expandable sink caddy of claim 1 wherein the back plate is of a greater width and greater height than the front plate.

7. The expandable sink caddy of claim 1 wherein the front plate is substantially rigid.

8. The expandable sink caddy of claim 7 wherein the front plate and the flexible section are unitarily formed.

9. The expandable sink caddy of claim 1 further comprising one or more bores formed in a lower portion of the expandable caddy.

10. The expandable sink caddy of claim 1 further comprising one or more bores in at least one of the flexible section, the front plate and the back plate.

11. The expandable sink caddy of claim 1 comprising one or more bores in the flexible section.

12. The expandable sink caddy of claim 11 wherein at least one of the one or more apertures in the flexible section are in the area extending between the bottoms of the front and back plates.

13. The expandable sink caddy of claim 1 further comprising a hanger extending from the back plate to aid in supporting the sink caddy.

14. The expandable sink caddy of claim 13 wherein the hanger comprises an inverted “L” member with one side of the inverted “L” intended to fit over the edge of a sink.

15. The expandable sink caddy of claim 1 wherein the front plate further comprises a tab for manipulating the sink caddy from the closed configuration to the open configuration.

16. The expandable sink caddy of claim 15 wherein the tab extends outwardly along a top edge of the front plate.

17. The expandable sink caddy of claim 15 wherein the tab extends upwardly from and outwardly along a top edge of the front plate.

18. The expandable sink caddy of claim 1 further comprising one or more bumpers formed on a rearward facing surface of the back plate.
